(19) United States
(12) Patent Application Publication
(10) Pub. No.: US 2018/0315226 A1
(43) Pub. Date: Nov. 1, 2018

(54) INFORMATION PROCESSING SYSTEM AND INFORMATION PROCESSING DEVICE

(71) Applicant: FUJITSU LIMITED, Kawasaki-shi (JP)

(72) Inventor: Machiko Ikoma, Meguro (JP)

(73) Assignee: FUJITSU LIMITED, Kawasaki-shi (JP)

(21) Appl. No.: 15/951,394

(22) Filed: Apr. 12, 2018

(30) Foreign Application Priority Data
Apr. 26, 2017 (JP) 2017-087556

(51) Int. Cl. G06T 11/20; G06Q 10/06; H04W 4/02; G06T 7/20

(52) U.S. Cl. CPC G06T 11/203; G06Q 10/0631; G06T 2207/30241; G06T 7/20; G06T 2207/30196; H04W 4/027

(57) ABSTRACT

An information processing system includes a user terminal, a database server, and a web server. The web server is configured to receive from the user terminal, in accordance with an electronic image of a retail environment, positional location data of a designated area within the retail environment. The web server is configured to transmit to the database server a request for positional location movement data for devices associated with customers who purchased merchandise stored with the designated area corresponding to the positional location, and receive the positional location movement data. The web server is configured to generate, based on the positional location movement data, drawing data for drawing marks that indicate moving routes within the retail environment of the customers who purchased merchandise stored with the designated area, and transmit the drawing data to the user terminal to cause the drawing marks to be displayed on the user terminal.

### CROSS-REFERENCE TO RELATED APPLICATION

This application is based upon and claims the benefit of priority of the prior Japanese Patent Application No. 2017-87556, filed on Apr. 26, 2017, the entire contents of which are incorporated herein by reference.

### FIELD

The embodiments discussed herein are related to an information processing system and an information processing device.

### BACKGROUND

A technology in which purchase information of a customer for a merchandise item is analyzed, based on a movement track of the customer in a retail store, and data used when a layout of merchandise items is determined has been known.

Japanese Laid-open Patent Publication No. 2005-309951 discusses related art.

Incidentally, there is a case in which a person (which will be hereinafter referred to as a user) who is in charge of determining a layout of merchandise items analyzes purchase results (for example, point of sales (POS) data or the like) of purchasers of the merchandise items and movement tracks of the purchasers, which are displayed on a screen, and grasps moving states in accordance with the purchase results.

However, for example, there is a case in which, when a large number of movement tracks are superimposed and displayed on the same screen, each of the movement tracks is complicated. In such a case, the user is not able to intuitively grasp the movement tracks, and therefore, it is difficult to grasp the moving states in accordance with purchase results.

### SUMMARY

According to an aspect of the present invention, provided is an information processing system for tracking customer movement in a retail environment. The information processing system includes a user terminal, a database server, and a web server. The database server stores, in correlation with each of a plurality of unique device identifiers associated with electronic devices located on the person of customers that enter the retail environment, data corresponding to positional locations demonstrating movement of the devices within the retail environment, and merchandise purchased by the customers from the retail environment. The web server is configured to receive from the user terminal, in accordance with an electronic image of the retail environment, positional location data of a designated area within the retail environment. The web server is configured to transmit to the database server a request for positional location movement data for devices associated with customers who purchased merchandise stored with the designated area corresponding to the positional location. The web server is configured to receive the positional location movement data from the database server. The web server is configured to generate, based on the positional location movement data, drawing data for drawing marks that indicate moving routes within the retail environment of the customers who purchased merchandise stored with the designated area. The web server is configured to transmit the drawing data to the user terminal to cause the drawing marks to be displayed on the user terminal.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example of an information processing system;

FIG. 2 is an example of a hardware configuration of a Web server;

FIG. 3 is an example of a function block diagram of a control device of a user terminal;

FIG. 4 is an example of a function block diagram of a Web server;

FIG. 5 is an example of a mapping table;

FIG. 6 is an example of a function block diagram of a DB server;

FIG. 7 is an example of a moving history table;

FIG. 8 is an example of a purchase result table;

FIG. 9 is an example of a merchandise item master table;

FIG. 10 is an example of an object master table;

FIG. 11 is a diagram illustrating an object positional relation;

FIG. 12 is an example of a floor master table;

FIG. 13 is an example of a first sequence diagram illustrating an example of an operation of an information processing system;

FIG. 14 is an example of a second sequence diagram illustrating the example of the operation of the information processing system;

FIG. 15 is an example of a display screen that is displayed on a user terminal;

FIG. 16 is a first operation example;

FIG. 17 is a second operation example;

FIG. 18 is a third operation example;

FIG. 19 is a first diagram illustrating an example of generation of drawing data;

FIG. 20 is a second diagram illustrating the example of generation of drawing data;

FIGS. 21A to 21D are diagrams each illustrating an example of gradation and color of a mark;

FIG. 22A is an example of a mark that is displayed when an object is not designated and FIG. 22B is an example of a mark that is displayed when an object is designated;

FIG. 23A is an example of a mark that is displayed when a time is not designated and FIG. 23B is an example of a mark that is displayed when a time is designated;

FIG. 24A is a diagram illustrating a flow line of a customer, which corresponds to moving history data, FIG. 24B is an example of a mark that corresponds to a flow line toward a left side, and FIG. 24C is an example of a mark that corresponds to a flow line toward a right side;

FIG. 25A is a diagram illustrating another flow line of the customer, which corresponds to the moving history data, FIG. 25B is an example of a mark that corresponds to a movement from the left side, and FIG. 25C is an example of a mark that corresponds to a movement from the right side; and

FIG. 26A is a diagram illustrating another flow line of the customer, which corresponds to the moving history data, and FIG. 26B is an example of a mark that corresponds to a movement from an area A to an area B.

### DESCRIPTION OF EMBODIMENTS

Embodiments will be described below with reference to the accompanying drawings.

### First Embodiment

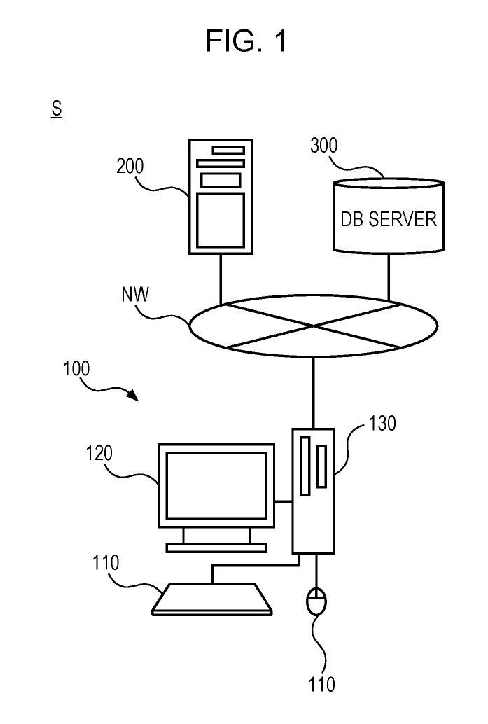

FIG. 1 is an example of an information processing system S. The information processing system S includes a user terminal 100, a Web server 200 as an information processing device, and a database (DB) server 300. In FIG. 1, as an example of the user terminal 100, a personal computer (PC) is illustrated but, for example, a smart device, such as a smart phone, a tablet terminal, or the like, a wearable device, such as a smart watch, or the like may be used. On the other hand, as the Web server 200 and the DB server 300, for example, a server device is used.

The user terminal 100, the Web server 200, and the DB server 300 are coupled to one another via a communication network NW. Examples of the communication network NW include, for example, a local area network (LAN), the Internet, or the like.

The user terminal 100 includes an input device 110, a display device 120, and a control device 130. The control device 130 receives information that has been input from the input device 110, controls a screen or an image, which is displayed on the display device 120, or transmits the received information to the Web server 200. Although details will be described later, as the above-described information, for example, there is operation information related to an operation of designating a condition or the like. On the other hand, the control device 130 receives various types of information that has been transmitted from the Web server 200 and causes an image that corresponds to the information to be displayed on the display device 120. Although details will be described later, as the above-described image, for example, there is a mark that indicates a movement track, a moving direction, moving speed, or the like of a visitor who purchased a merchandise item. The mark may be a mark that indicates a representative route of movement tracks of a plurality of visitors.

When the Web server 200 receives information that has been transmitted from the user terminal 100, the Web server 200 analyzes the received information and generates an extraction condition when data is extracted from the DB server 300. The Web server 200 acquires data from the DB server 300, based on the generated extraction condition. When the Web server 200 acquires the data, the Web server 200 generates an image (specifically, the above-described mark), based on the acquired data, and displays the generated image on the user terminal 100. More specifically, the Web server 200 transmits the generated image to the user terminal 100 and the user terminal 100 displays the received image.

The DB server 300 stores various types of data. As data that the DB server 300 stores, for example, there are merchandise item master data, POS data, moving history data, or the like. Other data that the DB server 300 stores will be described later. When the DB server 300 detects an acquisition request for data, based on the extraction condition that has been generated by the Web server 200, the DB server 300 extracts data that corresponds to the extraction condition and transmits the extracted data to the Web server 200.

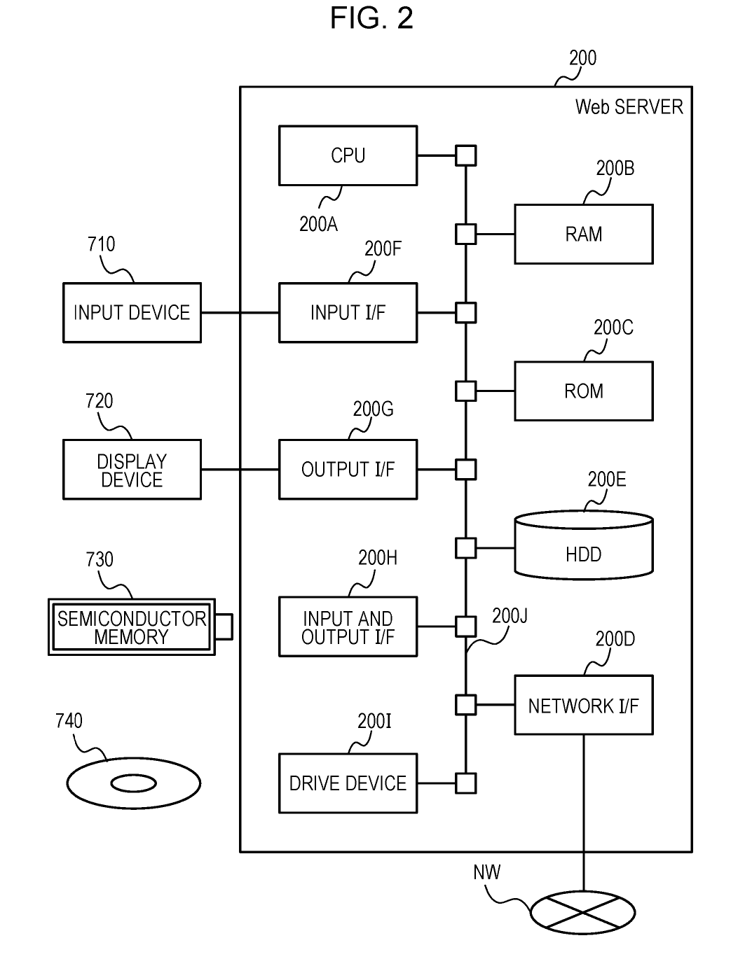

Next, with reference to FIG. 2, a hardware configuration of the Web server 200 will be described. Note that each of the user terminal 100 and the DB server 300, which have been described above, has basically a similar hardware configuration to that of the Web server 200 and therefore the description thereof will be omitted.

FIG. 2 is an example of a hardware configuration of the Web server 200. As illustrated in FIG. 2, the Web server 200 includes at least a central processing unit (CPU) 200A, a random access memory (RAM) 200B, a read only memory (ROM) 200C, and a network interface (I/F) 200D. The Web server 200 may be configured to include at least one of a hard disk drive (HDD) 200E, an input I/F 200F, an output I/F 200G, an input and output I/F 200H, and a drive device 2001, as appropriate. The components the CPU 200A to the drive device 2001 are coupled to one another via an internal bus 200J. At least the CPU 200A as a processor and the RAM 200B as a memory cooperate with one another, and thereby, a computer is realized. Note that, instead of the CPU 200A, a micro processing unit (MPU) may be used as a processor.

An input device 710 is coupled to the input I/F 200F. As the input device 710, for example, a keyboard, a pointing device (for example, a mouse), or the like is used. Note that the input device 110, which has been described above, is basically similar to the input device 710.

A display device 720 is coupled to the output I/F 200G. As the display device 720, for example, a liquid crystal display is used. Note that the display device 120, which has been described above, is basically similar to the display device 720.

A semiconductor memory 730 is coupled to the input and output I/F 200H. As the semiconductor memory 730, for example, a universal serial bus (USB) memory, a flash memory, or the like is used. The input and output I/F 200H reads a program or data which is stored in the semiconductor memory 730.

Each of the input I/F 200F and the input and output I/F 200H includes, for example, a USB port. The output I/F 200G includes, for example, a display port.

A portable recording medium 740 is inserted in the drive device 2001. As the portable recording medium 740, for example, a removable disk, such as a compact disk (CD)-ROM, a digital versatile disc (DVD), or the like, is used. The drive device 2001 reads a program or data that is recorded in the portable recording medium 740.

The network I/F 200D includes, for example, a LAN port. The network I/F 200D is coupled to the communication network NW.

In the RAM 200B, which has been described above, a program that has been stored in the ROM 200C or the HDD 200E is stored by the CPU 200A. In the RAM 200B, a program that has been recorded in the portable recording medium 740 is stored by the CPU 200A. The stored program is executed by the CPU 200A, and thereby, various functions, which will be described later, are realized, or various types of processing, which will be described later, are executed. Note that the program corresponds to a flowchart which will be described later.

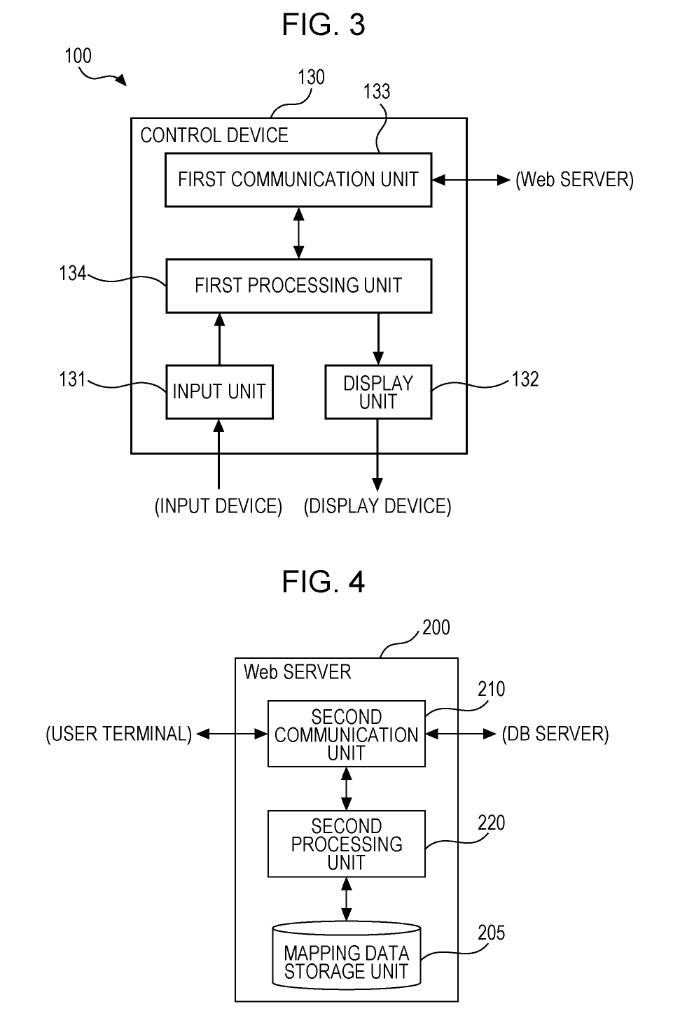

Next, with reference to FIG. 3 to FIG. 12, each of functions of the user terminal 100, the Web server 200, and the DB server 300 will be described.

FIG. 3 is an example of a function block diagram of the control device 130 of the user terminal 100. As illustrated in FIG. 3, the control device 130 includes an input unit 131, a display unit 132, a first communication unit 133, and a first processing unit 134. Note that the input unit 131, the display unit 132, and the first communication unit 133 are realized, for example, by the input I/F 200F, the output I/F 200G, and the network I/F 200D, which have been described above, respectively. Also, the first processing unit 134 is realized, for example, by the CPU 200A and the RAM 200B.

The input unit 131 receives information from the input device 110. As the information, there is the above-described operation information or the like. The display unit 132 transmits an image that corresponds to a result of processing performed by the first processing unit 134 to the display device 120. Thus, the display device 120 displays the image.

The first communication unit 133 controls a communication between the control device 130 and the Web server 200. For example, the first communication unit 133 transmits information that has been output from the first processing unit 134 to the Web server 200 and receives the image that has been transmitted from the Web server 200. Based on the information that has been received by the input unit 131, the first processing unit 134 generates a screen or an image which is displayed on the display device 120 or outputs the received information to the first communication unit 133.

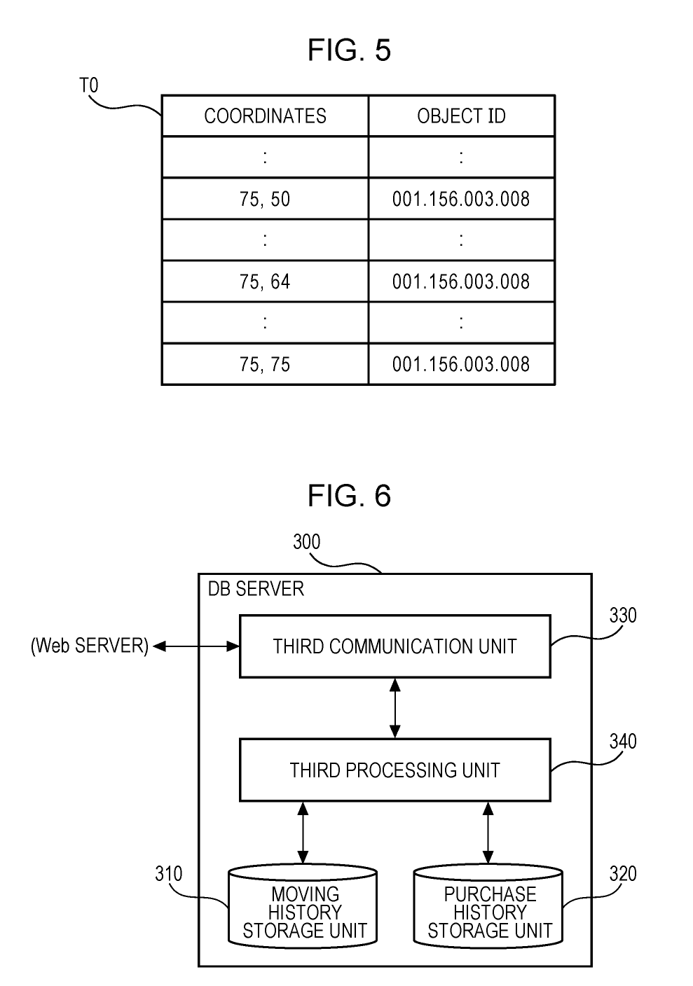

FIG. 4 is an example of a function block diagram of the Web server 200. FIG. 5 is an example of a mapping table T0. As illustrated in FIG. 4, the Web server 200 includes a mapping data storage unit 205, a second communication unit 210, and a second processing unit 220 as a processing unit. Note that the mapping data storage unit 205 is realized, for example, by the ROM 200C or the HDD 200E, which have been described above. The second communication unit 210 is realized, for example, by the above-described network I/F 200D. The second processing unit 220 is realized, for example, by the CPU 200A or the RAM 200B which have been descried above.

The mapping data storage unit 205 stores mapping data. More specifically, as illustrated in FIG. 5, the mapping data storage unit 205 manages mapping data by the mapping table TO. The mapping data includes, as component elements, coordinates and an object ID. The coordinates represent coordinates on coordinate axes of an overhead image of a floor, which is displayed on the display device 120. The object ID is identification information that identifies an object. Note that details of the object ID will be described later. It is enabled by the mapping table T0 to specify which object is associated with each of the coordinates.

The second communication unit 210 controls a communication between the user terminal 100 and the Web server 200 or controls a communication between the Web server 200 and the DB server 300. For example, the second communication unit 210 receives information that has been transmitted from the user terminal 100 or transmits an image.

The second processing unit 220 analyzes the information that has been received by the second communication unit 210 and generates an extraction condition when data is extracted from the DB server 300. The second processing unit 220 acquires data from the DB server 300 via the second communication unit 210, based on the generated extraction condition. When the second processing unit 220 acquires data via the second communication unit 210, the second processing unit 220 generates an image, based on the acquired data, and displays the generated image on the user terminal 100. More specifically, the second processing unit 220 transmits the generated image to the user terminal 100 and the user terminal 100 displays the received image. Note that the second processing unit 220 executes various types of processing, and details of the various types of processing which the second processing unit 220 executes will be described later.

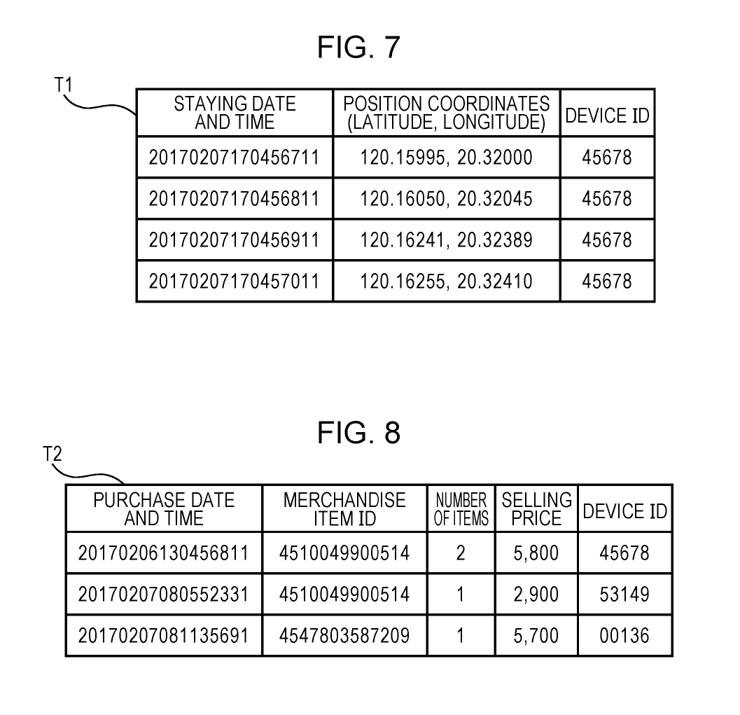

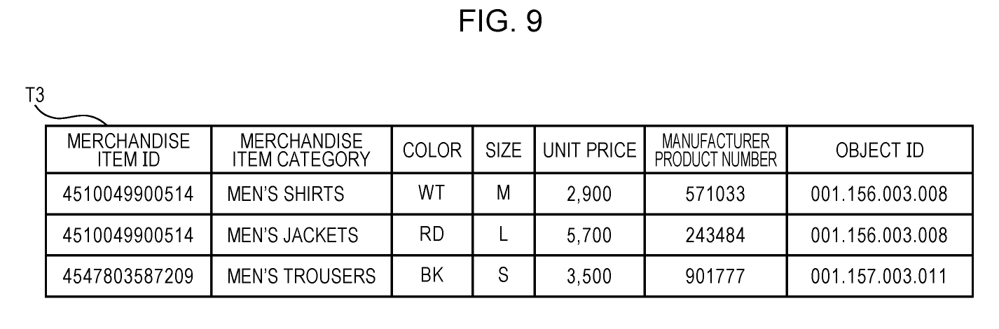

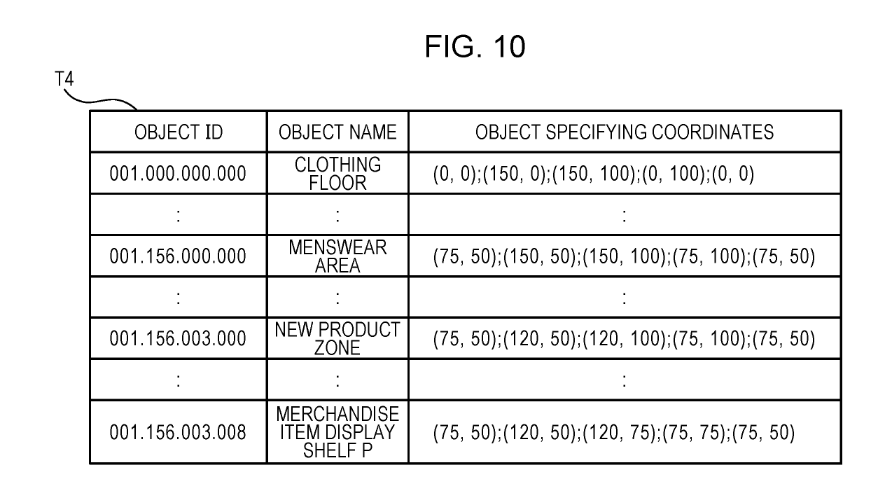

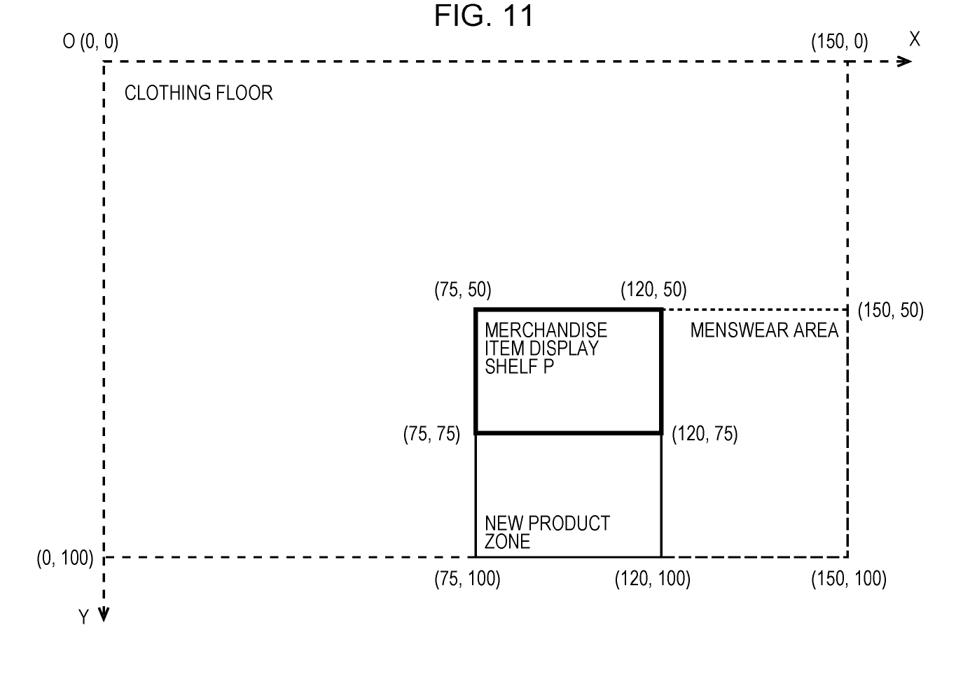

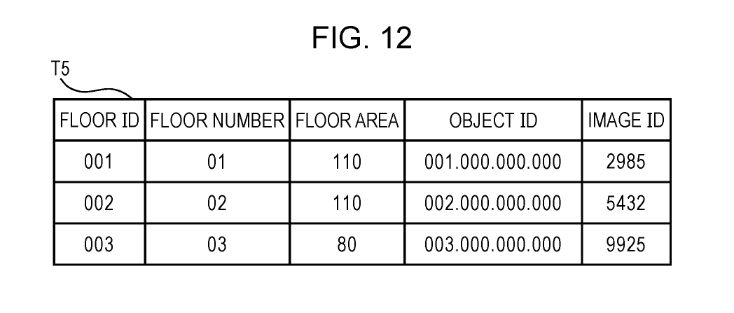

FIG. 6 is an example of a function block diagram of the DB server 300. FIG. 7 is an example of a moving history table T1. FIG. 8 is an example of a purchase result table T2. FIG. 9 is an example of a merchandise item master table T3. FIG. 10 is an example of an object master table T4. FIG. 11 is a diagram illustrating an object positional relation. FIG. 12 is an example of a floor master table T5.

As illustrated in FIG. 6, the DB server 300 includes a moving history storage unit 310, a purchase history storage unit 320, a third communication unit 330, and a third processing unit 340. Note that the moving history storage unit 310 and the purchase history storage unit 320 are realized, for example, by the HDD 200E, which has been described above. The third communication unit 330 is realized, for example, by the network I/F 200D, which has been described above. The third processing unit 340 is realized, for example, by the CPU 200A and the RAM 200B, which have been described above.

The moving history storage unit 310 stores moving history data that indicates a moving history of a customer who moves in a store. The customer is a visitor (that is, a purchaser) who visited the store and purchased a merchandise item. More specifically, as illustrated in FIG. 7, the moving history storage unit 310 manages the moving history data by the moving history table T1. The moving history data includes staying date and time, position coordinates, and a device ID as component elements. The staying date and time are date and time when the customer stayed in a location that is specified by the position coordinates or the customer passed the location. The position coordinates indicate coordinates of the location where the customer stayed. The position coordinates are represented by an absolute location including a latitude and a longitude but, for example, may be a relative position relative to a certain location as a reference point. The device ID is identification information that identifies a device (for example, a smartphone or the like), which is carried by the customer. The customer may be identified by the device ID. As illustrated in FIG. 7, if the position coordinates change with passage of the staying time and data, it is possible to specify that the customer that is identified by the device ID moved. Note that a radio wave that is transmitted by a device is detected by an access point set in the store or the like, and thereby, the moving history data may be generated.

The purchase history storage unit 320 stores POS data that indicates a purchase result of a customer who purchased a merchandise item. More specifically, as illustrated in FIG. 8, the purchase history storage unit 320 manages the POS date by the purchase result table T2. The POS data includes purchase date and time, a merchandise item ID, the number of items, a selling price, and the device ID as component elements. The purchase date and time are date and time when the customer purchased a merchandise item. The merchandise item ID is identification information that identifies a merchandise item. The number of items is the number of merchandise items that the customer purchased and the selling price is the amount of money that the customer paid when the customer purchased the merchandise item. As described above, a result of purchase of a merchandise item and a customer who purchased the merchandise item are associated with one another by the purchase result table T2, and thereby, it is enabled to identify when a merchandise item was sold, what merchandise item was sold, how many of the merchandise items were sold, on how match the merchandise item was sold, and to whom the merchandise item was sold.

Also, the purchase history storage unit 320 stores merchandise item master data that indicates details of merchandise items. More specifically, as illustrated in FIG. 9, the purchase history storage unit 320 manages the merchandise item master data using the merchandise item master table T3. The merchandise item master data includes a merchandise item ID, a merchandise item category, a color, a size, a unit price, a manufacturer product number, and an object ID as component elements. The merchandise item category is a merchandise item classification. The color, the size, and the unit price are a color, a size, and a price per item of a merchandise item, respectively. The manufacturer product number is information that is used when a manufacturer company which produced the merchandise item identifies the merchandise item. The object ID is identification information that identifies a generic name of an operation target that is displayed on a screen of the user terminal 100. Examples of the operation target are, for example, a floor, an area, a zone, a shelf, a shopping basket, an elevator, an escalator, stairs, or the like in a store. When an object is operated, the second processing unit 220 displays information including a result of purchase of a merchandise item directly or indirectly associated with the object ID that identifies the object that is operated on the user terminal 100. Note that the above-described floor is in a building including a plurality of layers and is each of the layers into which the building is divided floor by floor.

Furthermore, the purchase history storage unit 320 stores the object master data that indicates details of the above-described object. More specifically, as illustrated in FIG. 10, the purchase history storage unit 320 manages object master data using the object master table T4. The object master data includes an object ID, an object name, and object specifying coordinates as component elements. The object name is a name of an object. The object specifying coordinates are position coordinates that specify a zone that is occupied by the object. Specifically, the object specifying coordinates are indicated in a list format in which coordinates of vertexes are arranged in a clockwise direction.

Specifically, as illustrated in FIG. 11, a clothing floor is a zone specified by coordinates (150, 0), (150, 100), and (0, 100), which are arranged in a clockwise direction from a reference point O (0, 0), and the reference point O (0, 0). Similar to the clothing floor, a menswear area, a new product zone, and a merchandise item display shelf P are specified. The object specifying coordinates may be relative coordinates determined using an upper left end as a reference point, but also, may be absolute coordinates determined by the latitude and the longitude.

Note that, as illustrated in FIG. 10, the object ID may be subdivided into four identification information that identifies a floor, an area, a zone, and a shelf. For example, a twelfth digit to a tenth digit are identification information that identifies a floor. A ninth digit and a seventh digit are identification information that identifies an area. A sixth digit to a fourth digit are identification information that identifies a zone. A third digit to a first digit are identification information that identifies a shelf. As illustrated in FIG. 9, identification information and other identification information may be connected by a dot symbol and also a dot symbol may not to be used.

Furthermore, the purchase history storage unit 320 stores floor master data that indicates details of the above-described floor. More specifically, as illustrated in FIG. 12, the purchase history storage unit 320 manages the floor master data using the floor master table T5. The floor master data includes a floor ID, a floor number, a floor area, an object ID, and an image ID as component elements. The floor ID is identification information that identifies the floor master data. The floor number and the floor area indicate the number and area of the floor, respectively. The image ID is information that identifies a floor overhead image that overviews the floor. The floor overhead image may be identified by the image ID.

Returning to FIG. 6, the third communication unit 330 controls a communication between the Web server 200 and the DB server 300. For example, the third communication unit 330 detects a data acquisition request based on the extraction condition that has been generated by the Web server 200. For example, the third communication unit 330 transmits the data that has been extracted by the third processing unit 340 to the Web server 200.

When the third communication unit 330 detects the data acquisition request, the third processing unit 340 extracts data that corresponds to the extraction condition and outputs the extracted data to the third communication unit 330. For example, the third processing unit 340 extracts merchandise item master data that corresponds to the object ID included in the extraction condition from the purchase history storage unit 320 and specifies the corresponding merchandise item ID. When the third processing unit 340 specifies the merchandise item ID, the third processing unit 340 extracts POS data from the purchase history storage unit 320 and specifies the device ID that corresponds to the merchandise item ID that has been specified from the POS data. When the third processing unit 340 specifies the device ID, the third processing unit 340 extracts moving history data from the moving history storage unit 310 and selects the moving history data that corresponds to the device ID that has been specified from the moving history data. The third processing unit 340 outputs the selected moving history data to the third communication unit 330.

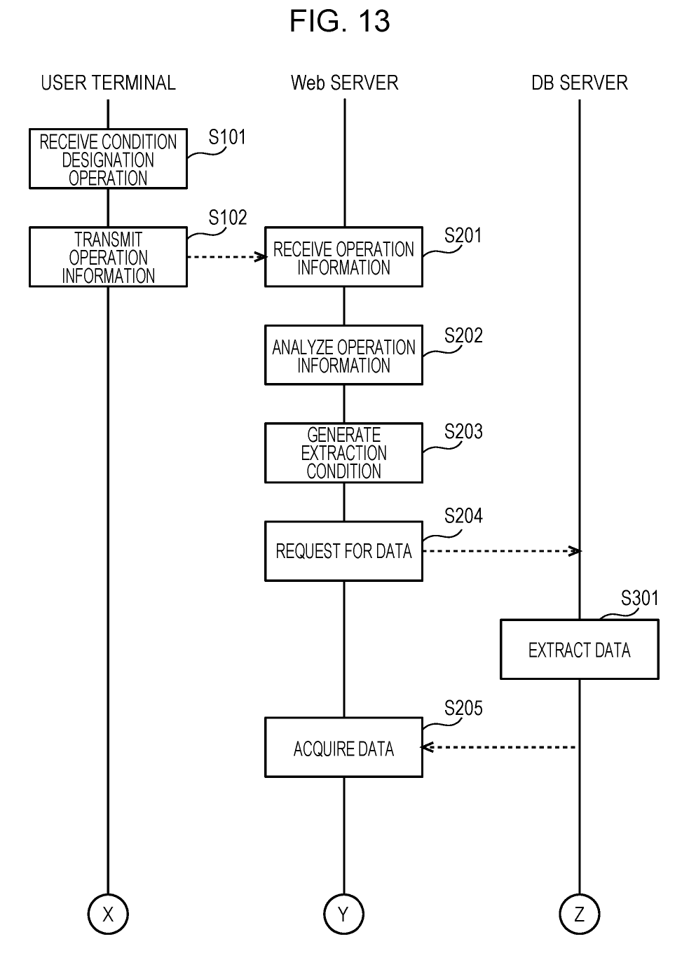

Subsequently, with reference to FIGS. 13 to FIG. 21D, various operations of the information processing system S will be described.

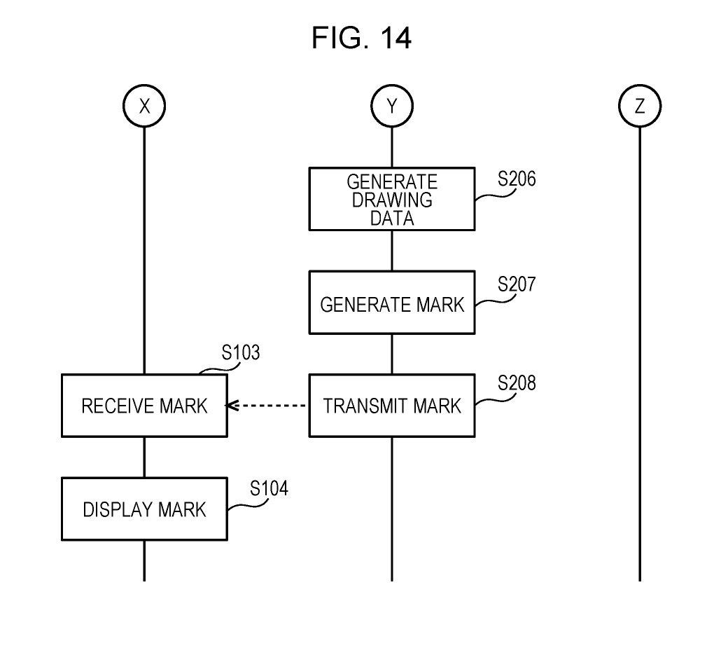

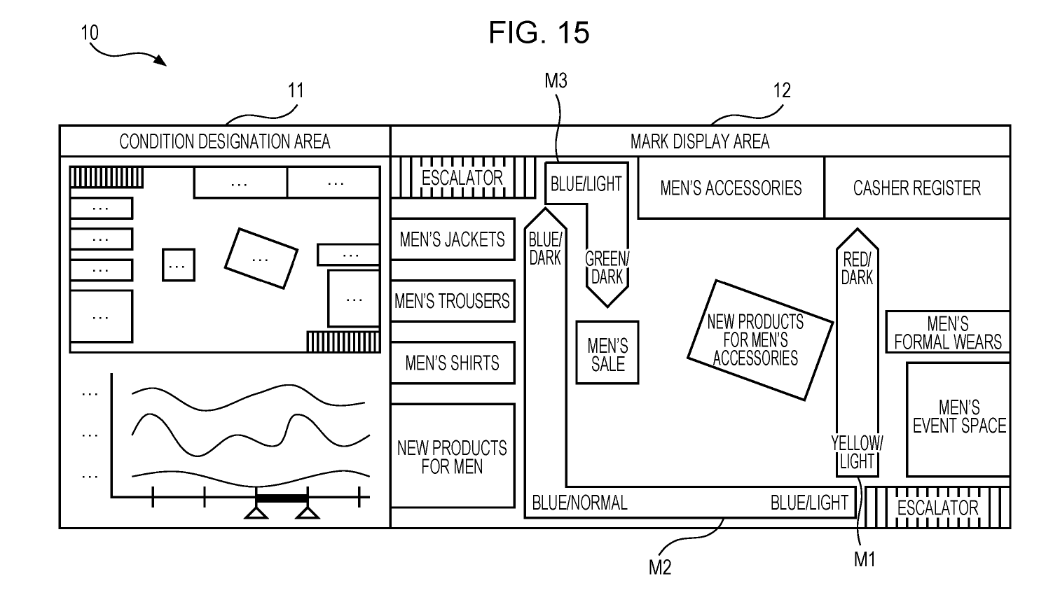

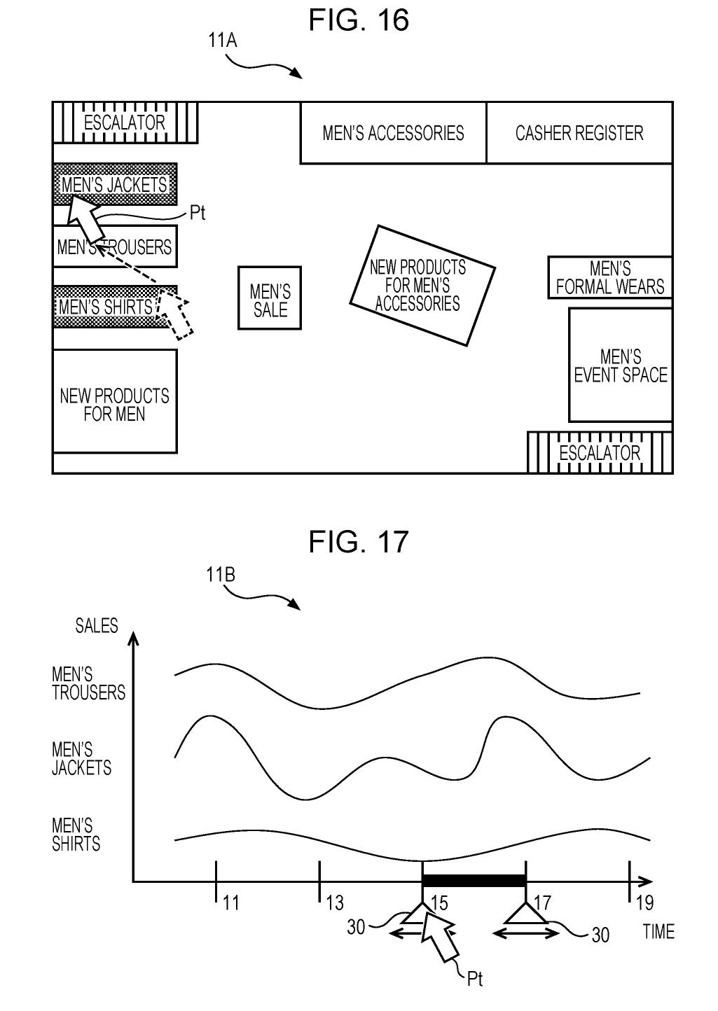

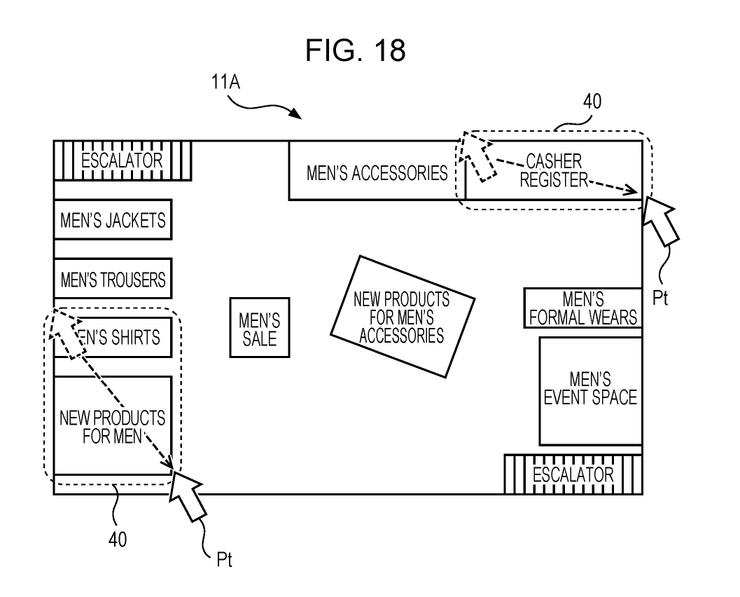

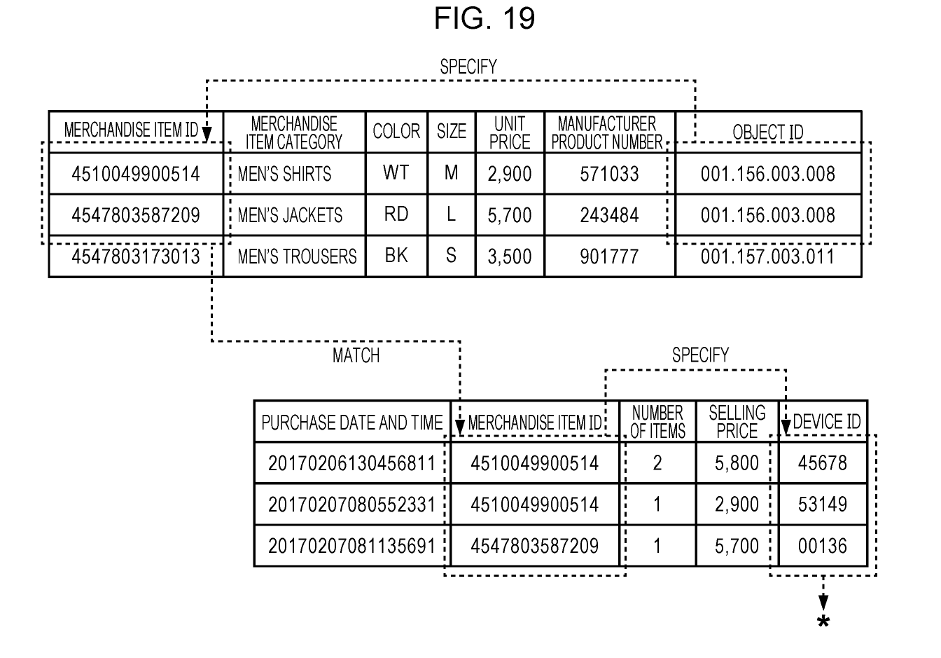

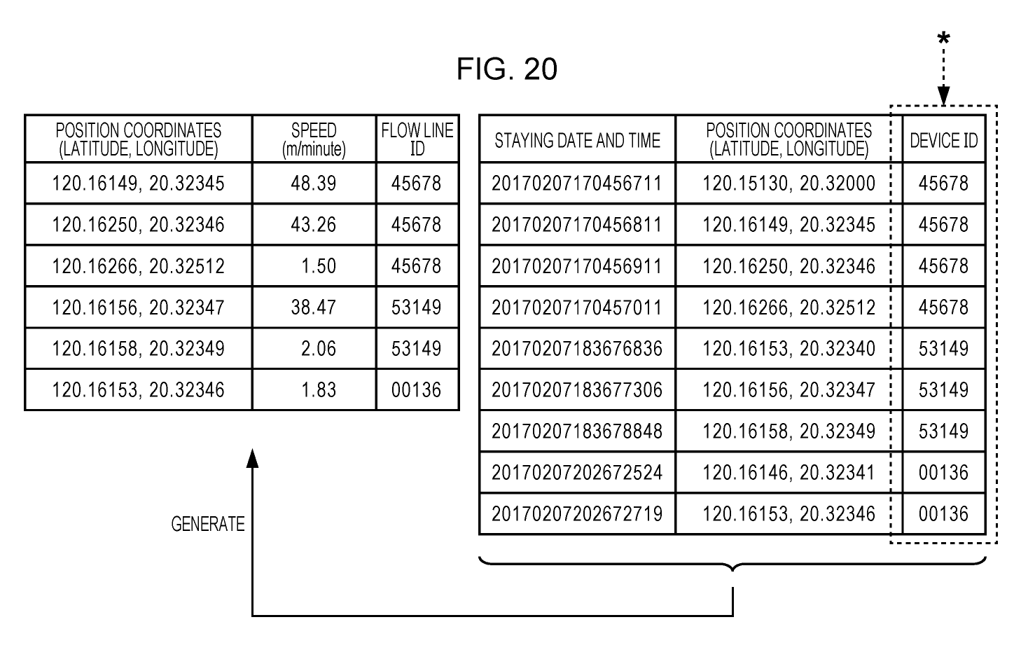

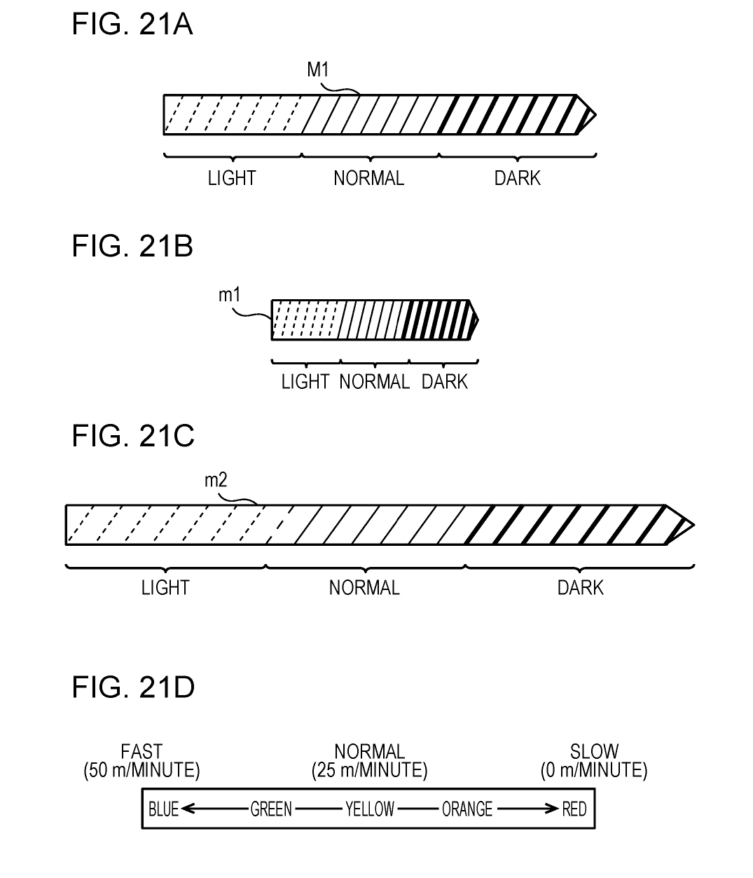

FIG. 13 is an example of a first sequence diagram illustrating an example of an operation of the information processing system S. FIG. 14 is an example of a second sequence diagram illustrating the example of the operation of the information processing system S. FIG. 15 is an example of the display screen 10 that is displayed on the user terminal 100. FIG. 16 is a first operation example. FIG. 17 is a second operation example. FIG. 18 is a third operation example. FIG. 19 is a first diagram illustrating an example of generation of drawing data. FIG. 20 is a second diagram illustrating an example of generation of drawing data. FIGS. 21A to 21D are diagrams each illustrating an example of gradation and color of a mark.

First, as illustrated in FIG. 13, the first processing unit 134 of the user terminal 100 receives a condition designation operation (Step S101). More specifically, the display device 120 of the user terminal 100 displays a display screen 10, as illustrated in FIG. 15. When a user operates the input device 110 to output an instruction to display the display screen 10 to the control device 130, the first processing unit 134 of the control device 130 displays the display screen 10 on the display device 120. As illustrated in FIG. 15, the display screen 10 includes a condition designation area 11 and a mark display area 12. The condition designation area 11 is an area in which conditions of marks M1, M2, and M3 that are displayed in the mark display area 12 are designated. Each of the marks M1, M2, and M3 indicates a moving route or a flow line of a customer who moves in the store.

For example, as illustrated in FIG. 16, in a partial area 11A included in the condition designation area 11, for example, it is possible to designate the merchandise item display shelf P on which men's shirts are displayed and a merchandise item display shelf Q on which men's jackets are displayed as objects using a pointer Pt. For example, as illustrated in FIG. 17, in a partial area 11B included in the condition designation area 11, it is possible to select a time period by moving a ruler 30 that designates a time using the pointer Pt. For example, as illustrated in FIG. 18, in the partial area 11A, it is possible to designate an object by an operation (for example, a drag operation) of designating a part 40 of the partial area 11A using the pointer Pt. The first processing unit 134 receives the condition designation operations that have been performed in the condition designation area 11.

Returning to FIG. 13, when the first processing unit 134 receives a condition designation operation, the first processing unit 134 transmits operation information to the Web server 200 (Step S102). More specifically, the first processing unit 134 transmits operation information that corresponds to the condition designation operation that has been received to the Web server 200. The operation information includes coordinates that specify a location on a screen which has been operated. Thus, the second communication unit 210 of the Web server 200 receives operation information (Step S201).

When the second communication unit 210 receives the operation information, the second processing unit 220 analyzes the operation information (Step S202) and generates an extraction condition (Step S203). More specifically, the second processing unit 220 extracts the coordinates included in the operation information and also extracts mapping data from the mapping data storage unit 205. Then, based on the extracted mapping data, the second processing unit 220 specifies the object ID associated with the extracted coordinates and generates an extraction condition including the specified object ID. When the second processing unit 220 generates the extraction condition, the second processing unit 220 requests the DB server 300 for data, based on the extraction condition (Step S204).

When data is requested by the second processing unit 220, the third processing unit 340 of the DB server 300 extracts data (Step S301). More specifically, first, the third processing unit 340 extracts the merchandise item master data or the like from the purchase history storage unit 320, based on the extraction condition. For example, when data is requested based on the extraction condition including the object ID “001. 156. 003. 008” which identifies the merchandise item display shelf P and the merchandise item display shelf Q that have been described above, as illustrated in FIG. 19, the third processing unit 340 specifies the merchandise item IDs “4510049900514” and “4547803587209”, based on the object ID “001. 156. 003. 008”.

Next, when the third processing unit 340 specifies these merchandise item IDs, the third processing unit 340 extracts the POS data from the purchase history storage unit 320. When the third processing unit 340 extracts the POS data, as illustrated in FIG. 19, the third processing unit 340 specifies device IDs “45678”, “53149”, and “00136” associated with the merchandise item IDs that match the specified merchandise item IDs. Thus, it is possible to specify customers who carry devices that are identified by the device IDs.

When the third processing unit 340 specifies these device IDs, subsequently, the third processing unit 340 extracts the moving history data from the moving history storage unit 310. When the third processing unit 340 extracts moving history data, as illustrated in FIG. 20, the third processing unit 340 selects moving history data that correspond to the specified device IDs. When the third processing unit 340 selects the moving history data, the third processing unit 340 transmits the selected moving history data to the Web server 200 via the third communication unit 330.

Returning to FIG. 13, the second processing unit 220 of the Web server 200 acquires data that has been transmitted from the DB server 300 (Step S205). Specifically, the second processing unit 220 acquires the moving history data that has been selected by the third processing unit 340. When the second processing unit 220 acquires the data, as illustrated in FIG. 14, the second processing unit 220 generates drawing data used for drawing the marks M1, M2, and M3 that indicate moving routes of a customer (Step S206).

For example, as illustrated in FIG. 20, the second processing unit 220 specifies position coordinates of two consecutive locations and two staying dates and times that correspond to the position coordinates for each device ID and calculates a change amount of the position coordinates of the two locations and a change amount of the two staying dates and times, thereby calculating speed at which the customer moved between the two locations indicated by the position coordinates. The second processing unit 220 generates drawing data including the calculated speed, the position coordinates after moving, and the device ID as the flow line ID. After completing generation of one drawing data, the second processing unit 220 starts generation of next drawing data by a similar method. As a result, as illustrated in FIG. 20, the second processing unit 220 generates a plurality of drawing data.

Returning to FIG. 14, when the second processing unit 220 generates drawing data, subsequently, the second processing unit 220 generates the marks M1, M2, and M3 for each flow line ID (Step S207). More specifically, the second processing unit 220 generates the marks M1, M2, and M3 that correspond to the drawing data. For example, the second processing unit 220 determines a length of the mark M1, based on the data number of the drawing data of the same flow line ID and, as illustrated in FIG. 21A, generates a color of a first part that indicates a moving source in the mark M1 with a low density, and generates a color of a second part that indicates a moving destination (or a moving direction) with a high density. Then, the second processing unit 220 generates a color of a third part (depicted by “NORMAL” in FIG. 21A) between the first part and the second part with an average density between the density of the first part and the density of the second part. For example, assuming that the entire length of the mark M1, which has been determined, is 100%, the second processing unit 220 sets 33% for the first part, 34% for the second part, and remaining 33% for the third part. Thus, the density of the mark M1 changes in a stepwise manner (so called gradation). Specifically, since the density increases in order from the first part to the second part, even when the mark M1 has a rectangular or elliptical shape or the like, which does not indicate a moving direction, it is possible to grasp the moving direction, based on a gradation of the density. Note that, even when the length that has been determined by the second processing unit 220 is, as illustrated in FIG. 21B, a mark m1 that is shorter than the mark M1, or is, as illustrated in FIG. 21C, a mark m2 that is longer than the mark M1, the second processing unit 220 determines the density with the same distribution as that of the mark M1. In this embodiment, change of the density is in three steps but the density may be caused to change in three or more steps. Thus, the density of the mark M1 changes in a stepwise manner at shorter intervals.

Also, the second processing unit 220 gives a color that corresponds to the calculated speed to the mark M1. Specifically, as illustrated in FIG. 21D, if the calculated speed is about 0 m/minute, the second processing unit 220 determines that the moving speed of the customer is slow and gives red to the mark M1. On the other hand, if the calculated speed is about 50 m/minute, the second processing unit 220 determines that the moving speed of the customer is fast and gives blue to the mark M1. As another option, in accordance with the calculated speed, the second processing unit 220 gives orange, yellow, and green to the mark M1, as illustrated in FIG. 21D. Note that each of change from yellow to red and change from yellow to blue is in a stepwise (so-called gradation). Therefore, for example, a color that is not expressed by the five colors is expressed by a mixed color of a plurality of colors.

As described above, it is possible to grasp the moving speed of the customer by various colors given to the mark M1 and to check a place at which the customer stopped or a place that the customer passed. As a result, it is possible to visually recognize the mark M1 including the color that indicates the moving speed and the gradation that specifies the moving direction, and therefore, the user is able to more accurately analyze a trend of the customer. Note that similar processing to processing performed on the mark M1 is performed on the marks M2 and M3 to achieve similar advantages.

Returning to FIG. 14, when the second processing unit 220 generates the marks M1, M2, and M3, the second processing unit 220 transmits the marks M1, M2, and M3 to the user terminal 100 (Step S208). When the first communication unit 133 of the user terminal 100 receives the marks M1, M2, and M3 that have been transmitted from the second processing unit 220 (Step S103), the first processing unit 134 displays the marks M1, M2, and M3 on the display device 120 (Step S104). Specifically, the above-described second processing unit 220 generates the marks M1, M2, and M3 in accordance with the drawing data, and therefore, the marks M1, M2, and M3 include position coordinates. If, when the first processing unit 134 displays the marks M1, M2, and M3 on the display device 120, the position coordinates included in the marks M1, M2, and M3 are absolute locations determined by the latitude and the longitude, the absolute locations may be converted to relative locations using the coordinates of the reference point O and the relationship with the latitude and the longitude of the reference point O. Thus, as illustrated in FIG. 15, the marks M1, M2, and M3 that correspond to a designated object are displayed on the mark display area 12.

According to the first embodiment, the Web server 200 includes the second processing unit 220. When the second processing unit 220 receives a designation of one of objects (for example, areas) included in the partial area 11A that indicates a floor overhead image, the second processing unit 220 refers to the purchase history storage unit 320 and specifies the device ID of a device that is carried by a customer who purchased a merchandise item that is handled by the designated object. Then, the second processing unit 220 refers to the moving history storage unit 310, acquires the moving history data of the specified device ID, and displays, based on the acquired moving history data, the marks M1, M2, and M3 that indicate moving routes of the specified device ID on the mark display area 12 that indicates the floor overhead image. Thus, it is possible to grasp a moving state that corresponds to a result of purchase of a purchaser who purchased a merchandise item.

Also, if a movement track is statically displayed on a screen, there is a probability that the user is not able to grasp a moving direction and moving speed of a purchaser. For example, the user may analyze a heat map or the like which indicates the moving speed of the purchaser with the movement track, but it is desired that the user has proficiency in order to perform analysis using both of the movement track and the heat map. However, according to the first embodiment, the moving direction and the moving speed of a purchaser are indicated by the gradations and colors of the marks M1, M2, and M3, and therefore, the user is able to intuitively grasp a moving state that corresponds to a result of purchase of the purchaser who purchased a merchandise item.

### Other Embodiments

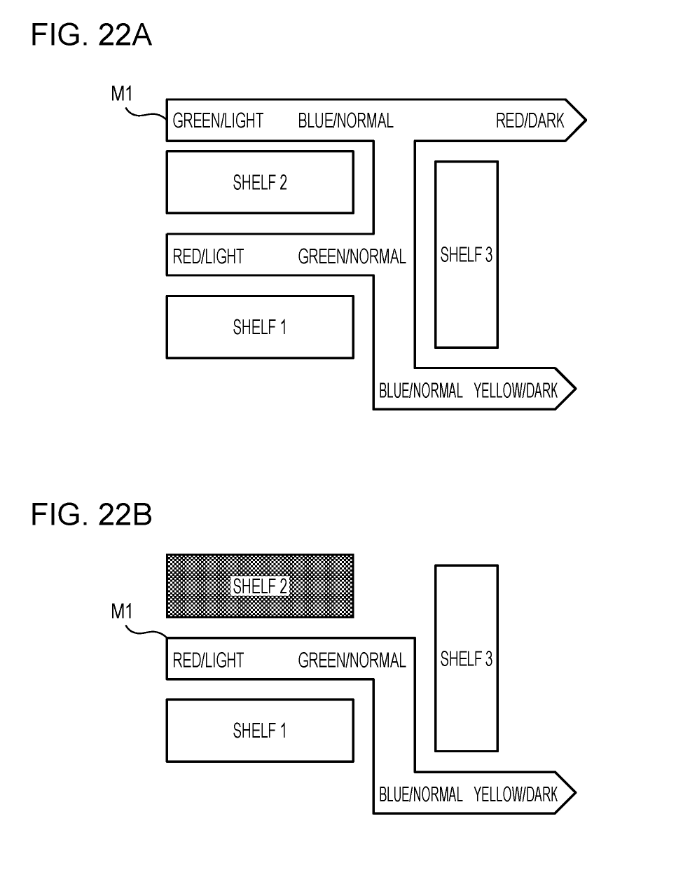

Subsequently, other embodiments will be described with reference to FIGS. 22A to 26B. Note that characters and symbols included in the mark M, which are indicated in FIGS. 22A to 26B, indicate the color and density of the mark M1. Specifically, a left side of a symbol “/” indicates a color and a right side indicates a density. In the mark M1 in each of FIGS. 22A to 26B, in a part in which no character and no symbol are indicted, a color and a density that compensate two parts in which characters are described in a stepwise manner are given. For example, the color gradually changes between a color “GREEN” and a color “BLUE”. Similarly, the density gradually changes between a density “LIGHT” and a density “NORMAL”. Also, the density gradually changes between the density “NORMAL” and a density “DARK”.

FIG. 22A is an example of the mark M1 that is displayed when an object is not designated. FIG. 22B is an example of the mark M1 that is displayed when an object is designated. Specifically, an example of the mark M1 that is displayed when a shelf 2 as an object is designated is illustrated. First, if an object is not designated in the above-described partial area 11A, the second processing unit 220 is not able to specify the object ID (see FIG. 19), and therefore, the second processing unit 220 generates the mark M1 that corresponds to all drawing data, regardless of the device ID. Thus, if an object is not designated, as illustrated in FIG. 22A, the first processing unit 134 displays the mark M1 on the display device 120, regardless of an object (specifically, shelves 1, 2, and 3). On the other hand, if the shelf 2 is designated as an object in the above-described partial area 11A, the second processing unit 220 is able to specify the object ID in accordance with coordinates of the shelf 2 that has been designated, and therefore, the second processing unit 220 generates the mark M1 that corresponds to drawing data that corresponds to the object ID. Thus, as illustrated in FIG. 22B, the first processing unit 134 displays the mark M1 associated with the shelf 2 as an object on the display device 120. Thus, it is possible to visualize the mark M1 of a customer who purchased a merchandise item from the shelf 2 that has been designated.

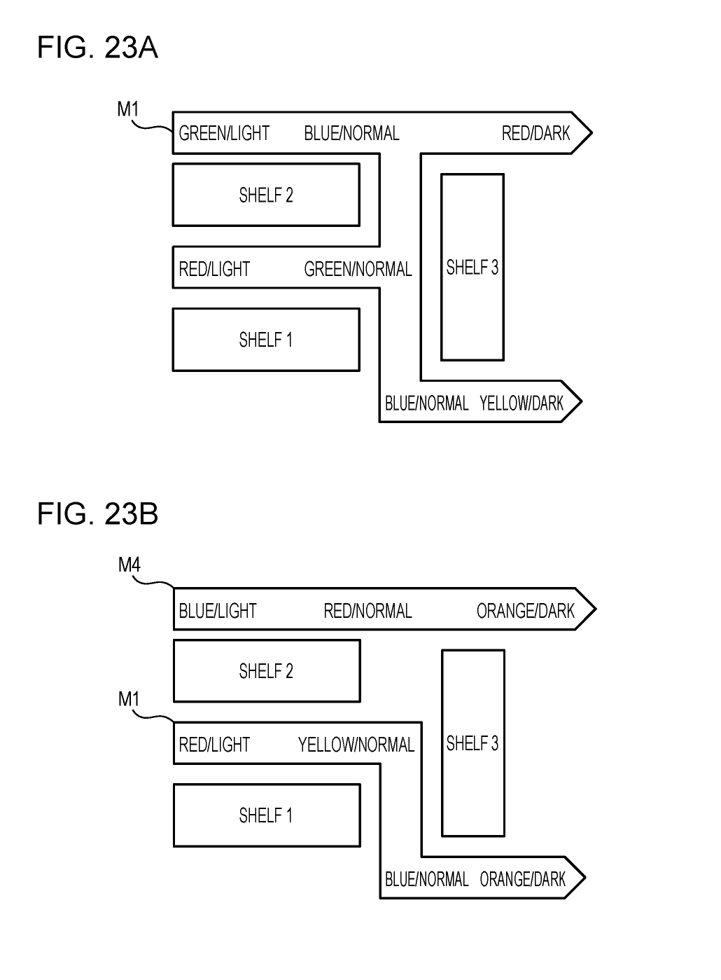

FIG. 23A is an example of the mark 1 that is displayed when a time is not designated. FIG. 23B is an example of the mark M1 that is displayed when a time is designated. Specifically, an example of the mark M1 that is displayed when a time period “from 15:00 to 17:00” (see FIG. 17) is selected is illustrated. First, if a time is not designated in the above-described partial area 11B, the second processing unit 220 is not able to specify the purchase date and time (see FIG. 19), and therefore, the second processing unit 220 generates the mark M1 that corresponds to all drawing data, regardless of the device ID. Thus, as illustrated in FIG. 23A, if a time is not designated, the first processing unit 134 displays the mark M1 on the display device 120, regardless of the time. On the other hand, when a time “15:00” and a time “17:00” are designated in the partial area 11B, the second processing unit 220 is able to specify purchase date and time in accordance with the time period “from 15:00 to 17:00” based on the designated times, and therefore, the second processing unit 220 generates the mark M1 that corresponds to drawing data that corresponds to the purchase date and time. Thus, as illustrated in FIG. 23B, the first processing unit 134 displays the marks M1 and M4 associated with the time period “from 15:00 to 17:00” on the display device 120. Thus, it is possible to visualize the marks M1 and M4 of a customer who purchased a merchandise item in the selected time period.

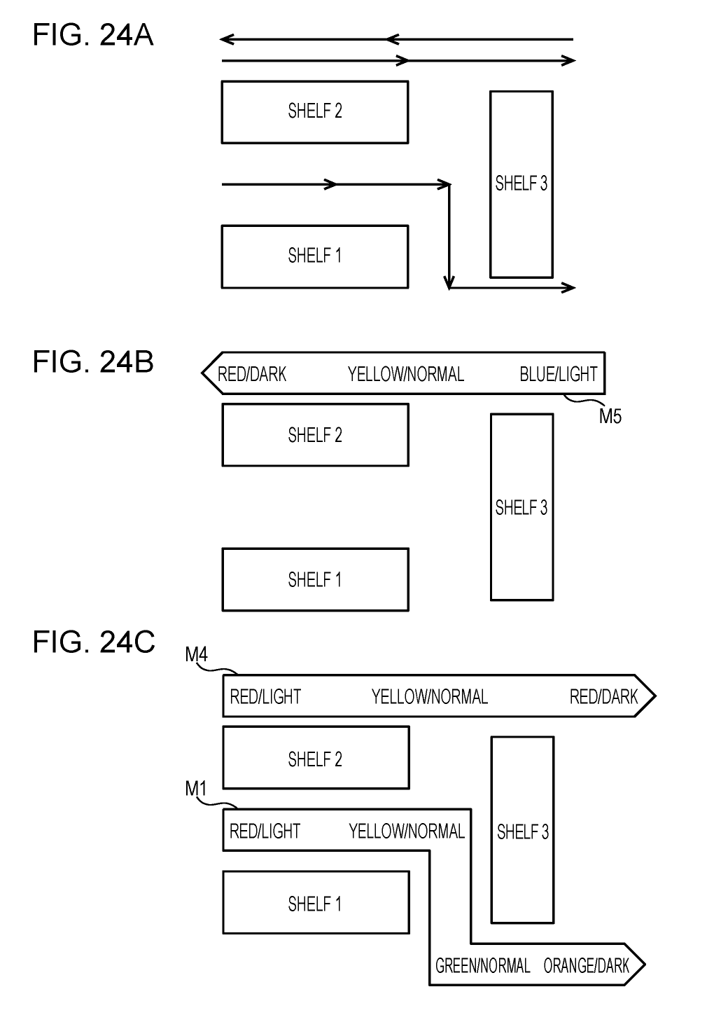

FIG. 24A is a diagram illustrating a flow line of a customer, which corresponds to moving history data. Specifically, a flow line of a customer who moves in a specific direction on one of a plurality of paths and a flow line of a customer who moves in an opposite direction to the specific direction on the path are illustrated. FIG. 24B is an example of a mark M5 that corresponds to a flow line toward a left side. FIG. 24C is an example of the mark M1 and the mark M4 that correspond to a flow line toward a right side. A configuration in which, as illustrated in FIG. 24A, if the flow line of the customer, which is indicated in accordance with the moving history data, includes both of a flow line toward the left side and a flow line toward the right side, the second processing unit 220 generates and displays the mark M5 that corresponds to the flow line toward the left side, as illustrated in FIG. 24B, or generates and displays the marks M1 and M4 that correspond to the flow line toward the right side, as illustrated in FIG. 24C, may be employed. Also, a configuration in which selection items used for selecting the directions of the marks M1, M4, and M5, which are to be displayed, are provided in the condition designation area 11 and the second processing unit 220 selectively generates and displays the mark 5 or one of the marks M1 and M4 in accordance with the selected direction may be employed. Note that, instead of left and right, for example, up and down directions may be used.

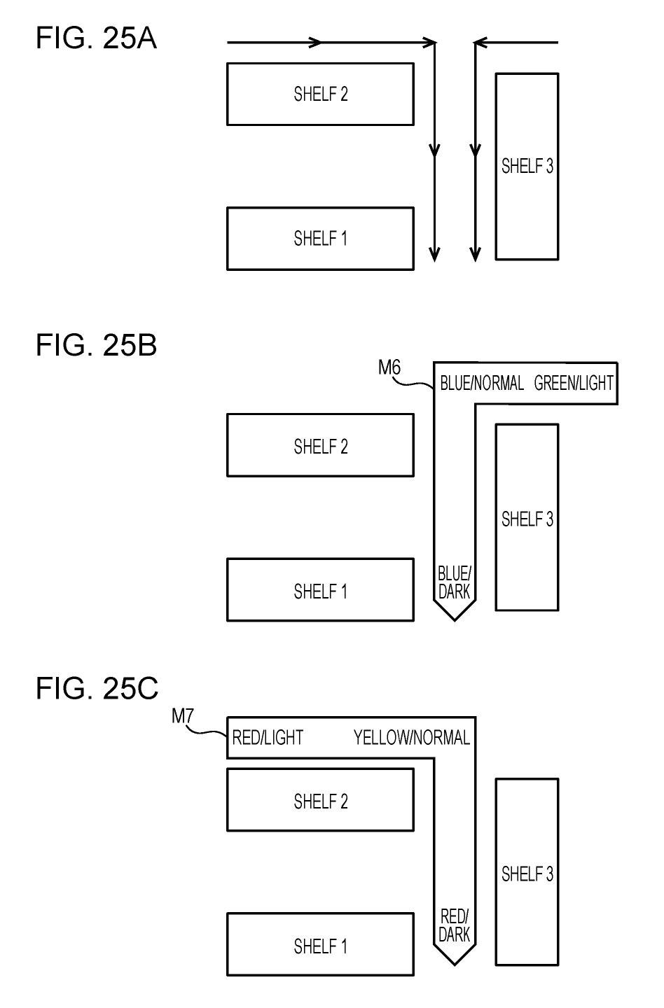

FIG. 25A is a diagram illustrating another flow line of the customer, which corresponds to the moving history data. FIG. 25B is an example of a mark M6 that corresponds to a movement from the left side. FIG. 25C is an example of a mark M7 that corresponds to a movement from the right side. A configuration in which, as illustrated in FIG. 25A, if a flow line of a customer, which is indicated in accordance with the moving history data, includes both of a flow line that indicates a movement from the left side and a flow line that indicated a movement from the right side, the second processing unit 220 generates and displays the mark M6 that corresponds to a movement form the left side, as illustrated in FIG. 25B, or generates and displays the mark 7 that corresponds to a movement from the right side, as illustrated in FIG. 25C, may be employed. Also, a configuration in which selection items that are used for selecting a moving source of each of the marks M6 and M7 which are to be displayed are provided in the condition designation area 11 and the second processing unit 220 selectively generates and displays one of the mark M6 and the mark M7 in accordance with the selected moving source may be employed. Note that, instead of left and right, for example, up and down directions may be used.

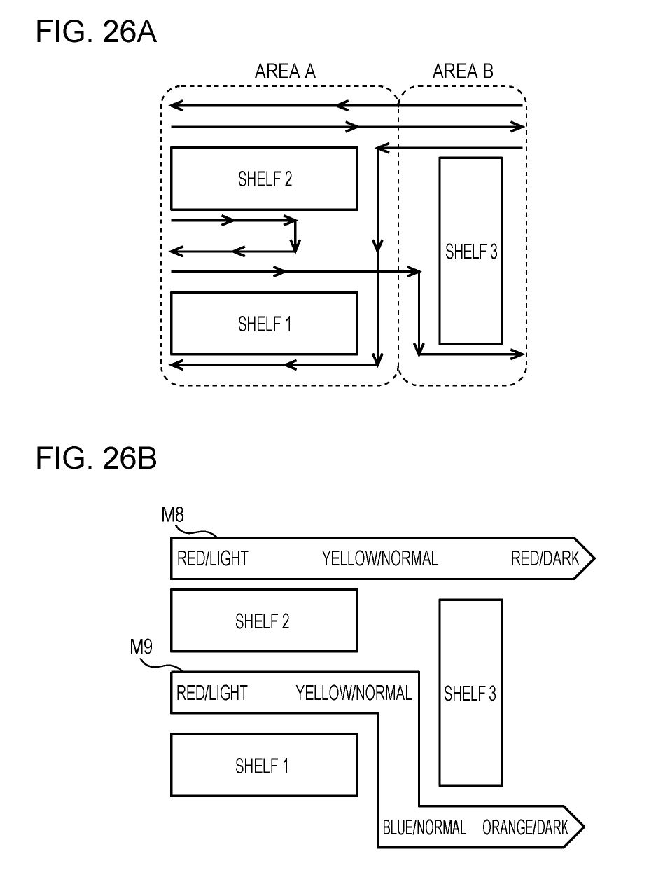

FIG. 26A is a diagram illustrating another flow line of the customer, which corresponds to the moving history data. Specifically, a flow line of the customer who moves on one of a plurality of paths is illustrated. In particular, FIG. 26A illustrates a flow line of the customer who moves in one or both of two areas A and B. FIG. 26B is an example of marks M8 and M9 that correspond to a movement from the area A to the area B. A configuration in which, as illustrated in FIG. 26A, if the flow lines of the customer, which are indicated in accordance with the moving history data, include a flow line that indicates a movement from the area A to the area B, a flow line that indicates a movement from the area B to the area A, and a flow line that indicates a movement in the area A, the second processing unit 220 generates and displays the marks M8 and M9 that correspond to the movement from the area A to the area B, as illustrated in FIG. 26B, may be employed. Although not illustrated, the second processing unit 220 may be configured to generate and display a mark that corresponds to a movement from the area B to the area A. Also, a configuration in which selection items that are used for selecting the moving directions of the marks M8 and M9 in the area A and the area B, which are to be displayed, are provided in the condition designation area 11 and the second processing unit 220 generates the marks M8 and M9 in accordance with the selected moving direction may be employed. For example, the second processing unit 220 may be configured to specify via which area the customer who moved on one of the paths indicated in FIG. 26A had moved before the customer entered the one of the paths and display a mark that indicates a moving route of the customer who moved on the one of the paths for each specified area.

Although preferred embodiments have been described in detailed above, the present disclosure is not limited to specific embodiments and various modifications and changes may be made to those embodiments without departing from the scope of the present disclosure as set forth in the claims. For example, all or a part of processing that are executed by the Web server 200 or the DB server 300, which have been described above, may be executed by the user terminal 100. Specifically, although, in the processing of Step S207, which has been described above, the second processing unit 220 generates the marks M1, M2, and M3 and transmits the marks M1, M2, and M3 to the user terminal 100 and the control device 130 (specifically, the first processing unit 134) of the user terminal 100 displays the marks M1, M2, and M3 on the display device 120, the second processing unit 220 may be configured to directly display the marks M1, M2, and M3 on the display device 120.

Also, the second processing unit 220 may be configured to calculate a customers' movement characteristic from the moving history data of a customer who moved on a route that corresponds to a mark that corresponds to position coordinates designated by an operation. Then, the second processing unit 220 may be configured to specify, based on information of a purchase history associated with a location on a floor overhead image, a purchase state of a merchandise item that corresponds to the designated location and display the calculated movement characteristic and the specified purchase state on a screen. Specifically, the second processing unit 220 may be also configured to perform determination on whether or not the calculated movement characteristic satisfies a specific condition and specify, if the calculated movement characteristic satisfies the specific condition, a purchase state of a product that corresponds to the designated location. Examples of the movement characteristic include, for example, a visit rate or the like, and examples of the purchase state include, for example, a purchase rate or the like. Note that the visit rate or the purchase rate may be calculated by a method of in-store merchandising (ISM).

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system for tracking customer movement in a retail environment, the information processing system comprising:
a user terminal;
a database server for storing, in correlation with each of a plurality of unique device identifiers associated with electronic devices located on the person of customers that enter the retail environment, data corresponding to positional locations demonstrating movement of the devices within the retail environment, and merchandise purchased by the customers from the retail environment; and
a web server configured to:
receive from the user terminal, in accordance with an electronic image of the retail environment, positional location data of a designated area within the retail environment,
transmit to the database server a request for positional location movement data for devices associated with customers who purchased merchandise stored with the designated area corresponding to the positional location,
receive the positional location movement data from the database server,
generate, based on the positional location movement data, drawing data for drawing marks that indicate moving routes within the retail environment of the customers who purchased merchandise stored with the designated area, and
transmit the drawing data to the user terminal to cause the drawing marks to be displayed on the user terminal.

2. The information processing system according to claim 1, wherein the web server is further configured to:
select some of the moving routes, and
generate drawing data for drawing marks that indicate the selected moving routes.

3. The information processing system according to claim 2, wherein the web server is further configured to:
select one of two moving routes that indicate movements through a path in opposite directions with each other; and
generate drawing data for a drawing mark that indicates the selected one route.

4. The information processing system according to claim 2, wherein the web server is further configured to:
select one of two moving routes that indicate movements through a path in a same direction following movements through different paths from each other; and
generate drawing data for a drawing mark that indicates the selected one route.

5. The information processing system according to claim 1, wherein each of the drawing marks is a mark in which a gradation of a display color changes in accordance with a moving direction on the electronic image of the retail environment.

6. The information processing system according to claim 5, wherein each of the drawing marks is a mark in which the gradation of the display color changes in a stepwise manner in accordance with the moving direction.

7. The information processing system according to claim 5, wherein each of the drawing marks is a mark in which the display color changes in accordance with moving speed.

8. An information processing device for tracking customer movement in a retail environment, the information processing device comprising:
a communication interface for electronically communicating with a user terminal and a database server storing, in correlation with each of a plurality of unique device identifiers associated with electronic devices located on the person of customers that enter the retail environment, data corresponding to positional locations demonstrating movement of the devices within the retail environment, and merchandise purchased by the customers from the retail environment; and
a processor configured to:
receive from the user terminal, in accordance with an electronic image of the retail environment, positional location data of a designated area within the retail environment,
transmit to the database server a request for positional location movement data for devices associated with customers who purchased merchandise stored with the designated area corresponding to the positional location,
receive the positional location movement data from the database server,
generate, based on the positional location movement data, drawing data for drawing marks that indicate moving routes within the retail environment of the customers who purchased merchandise stored with the designated area, and
transmit the drawing data to the user terminal to cause the drawing marks to be displayed on the user terminal.

9. A non-transitory computer-readable recording medium having stored therein a program that causes a computer for tracking customer movement in a retail environment to execute a process, the process comprising:
receiving from a user terminal, in accordance with an electronic image of the retail environment, positional location data of a designated area within the retail environment;
transmitting to a database server a request for positional location movement data for devices associated with customers who purchased merchandise stored with the designated area corresponding to the positional location, the database server storing, in correlation with each of a plurality of unique device identifiers associated with electronic devices located on the person of customers that enter the retail environment, data corresponding to positional locations demonstrating movement of the devices within the retail environment, and merchandise purchased by the customers from the retail environment;
receiving the positional location movement data from the database server;
generating, based on the positional location movement data, drawing data for drawing marks that indicate moving routes within the retail environment of the customers who purchased merchandise stored with the designated area; and
transmitting the drawing data to the user terminal to cause the drawing marks to be displayed on the user terminal.
